(19) United States
(12) Patent Application Publication
(10) Pub. No.: US 2023/0213207 A1
(43) Pub. Date: Jul. 6, 2023

(54) INTERIOR MATERIAL FOR COOKING APPARATUS, COOKING APPARATUS AND METHOD FOR REMOVING STAIN THEREFROM

(71) Applicant: SAMSUNG ELECTRONICS CO., LTD., Suwon-si (KR)

(72) Inventors: Jino KIM, Suwon-si (KR); Jeongeun SHIN, Suwon-si (KR); Youngdeog KOH, Suwon-si (KR); Jungsoo LIM, Suwon-si (KR)

(73) Assignee: SAMSUNG ELECTRONICS CO., LTD., Suwon-si (KR)

(21) Appl. No.: 17/988,870

(22) Filed: Nov. 17, 2022

Related U.S. Application Data
(63) Continuation of application No. PCT/KR2022/015872, filed on Oct. 18, 2022.

(30) Foreign Application Priority Data
Dec. 31, 2021 (KR) 10-2021-0193905

(51) Int. Cl. F24C 15/00; F24C 14/02

(52) U.S. Cl. CPC F24C 15/005; F24C 14/02

(57) ABSTRACT

An interior material for cooking apparatus having good anti-staining and heat-resisting properties and strong surface intensity, easy to clean, and restorable from contamination, a cooking apparatus including the interior material therefor and method for removing stains from the interior material. The interior material for the cooking apparatus is formed of a coated layer including a silicon backbone and a fluorine functional group is formed on a base material.

### CROSS-REFERENCE TO RELATED APPLICATIONS

This application is a continuation application, under 35 U.S.C. § 111(a), of International Patent Application No. PCT/KR2022/015872, filed on Oct. 18, 2022, which claims the benefit of Korean Patent Application No. 10-2021-0193905, filed Dec. 31, 2021, in the Korean Intellectual Property Office, the entire disclosures of each of which are incorporated herein by reference as a part of this application.

### BACKGROUND

### Field

The disclosure relates to an interior material for cooking apparatus having good anti-staining and heat-resisting properties and strong surface intensity, easy to clean, and restorable from contamination, a cooking apparatus including the interior material therefor and method for removing stains from the cooking apparatus.

### Description of Related Art

Traditional cooking apparatuses such as ovens provide cleaning methods for interior cleaning after cooking such as a high-temperature pyrolysis process, e.g., self cleaning or pyro cleaning; continuous catalytic cleaning that decomposes a catalyst by heat used during cooking; steam cleaning that uses steam cleaning power; easy cleaning that floats contaminants on hydrophilic surfaces.

The self cleaning needs to be performed at a high temperature of 500 [symbol] or more for 5 hours max and the pyro cleaning requires 2 to 4 hours at a high-temperature of 420 [symbol] or more in the oven, causing high-energy loss for cleaning and user risks due to high temperatures, and the cleaning methods need to be repeated each time food remnants and grease spots are made.

The continuous catalytic cleaning requires extra catalytic liners to remove an object to be decomposed, in which case when contamination is saturated, contaminants are rather accumulated, the catalytic function is not activated, and the contaminant accumulation is accelerated, which is referred to as poisoning.

The steam cleaning and easy cleaning are effective for light contamination or when cleaning is performed in a hot state but noticeably less effective for accumulated or heavy contamination, and require pyrolysis at a high temperature of 500 [symbol] or more to remove stains of saturated fat, e.g., grease in particular, carbonized and stuck on the surface.

After all, a tool such as a scrubber, a chemical detergent, an abrasive, etc., is used to remove the contaminants and grease spots after cooking, and much efforts are needed for cleaning and much energy is consumed for the pyrolysis at a high temperature of 500 [symbol] or more.

Furthermore, enamel coating is applied to the interior of the traditional cooking apparatus for protection of interior surfaces and antibacterial effect, but when the enamel is contaminated by an object being cooked, the contaminant is fixed on the enamel surface while being heated, making it difficult for cleaning, which also influences on hygiene.

In the meantime, Japanese patent publication No. 2005-230162 discloses that inner walls of an oven is vibrated to tear off adhered matters, which works, however, for a contaminant having relatively large volume and does not work for removal of grease constantly adhered even onto a coated film.

To solve the problem, there is a need to develop an interior material for cooking apparatus and method for removing contaminants, which is different from existing ones and capable of making it difficult for adherence of contaminants such as grease or making it easy for cleaning even when the contaminants are formed and removing greasy stains even by low-temperature heating.

### SUMMARY

According to an embodiment of the disclosure, an interior material for cooking apparatus comprising: a coated layer formed on a base material, wherein the coated layer comprises a silicon backbone and a fluorine functional group, having improved heat-resisting and anti-contaminating properties.

Enamel may be provided between the base material and the coated layer.

The silicon backbone may be derived from a silicone-containing compound including one or more functional groups of a silanol group, an alkoxysilyl group and a siloxane group. The fluorine functional group may be derived from a fluorine-containing compound having at least two fluorine atoms

The coated layer may be formed of a composition including 20 wt % to 60 wt % of the silicon-containing compound and 20 wt % to 40 wt % of the fluorine-containing compound.

The composition may further include one or more coupling agents selected from a group including an alkoxysilane-based compound, a chlorosilane-based compound, a silanol-based compound, an amine-based compound, a carbamate-based compound, an ester-based compound, and an ether-based compound.

The coated layer may be formed by sintering a composition including the silicon-containing compound and the fluorine-containing compound at 200 to 400 [symbol] .

The interior material for cooking apparatus may have a surface energy of 14 mN/m to 30 mN/m.

The base material may include at least one selected from a group including metal, alloy, stainless steel and glass.

According to an embodiment of the disclosure, provided is a method of removing a stain from a cooking apparatus. The method includes heating the cooking apparatus at a certain temperature to pyrolyze components of the stain deposited on a surface of a coated layer, the cooking apparatus including an interior material having the coated layer including a silicon backbone and a fluorine functional group formed on a base material; maintaining a temperature equilibrium until the pyrolysis of the stain components is completed; and performing cooling after completion of the pyrolysis of the stain components.

The heating of the cooking apparatus may include raising the temperature to 280 [symbol] to 350 [symbol] for 10 to 20 minutes. The maintaining of the temperature equilibrium may include performing heating at 350±10 [symbol] for 40 to 120 minutes. The performing of the cooling may include performing cooling for 20 to 30 minutes.

The stains may include a carbon chain as a main component.

The interior material for cooking apparatus may include enamel provided between the base material and the coated layer.

In an embodiment of the disclosure, provided is a cooking apparatus including a case including a front panel; a cooking chamber arranged inside the case and to accommodate food; a heater configured to heat the cooking chamber; and a door arranged to open or close the cooking chamber, wherein the cooking chamber is formed of an interior material having a coated layer formed on a base material, and the coated layer comprises a silicon backbone and a fluorine functional group.

The cooking apparatus may include a display configured to indicate a time for cleaning the cooking apparatus; and a manipulation unit arranged on a front surface of the case for controlling an operation of the cooking apparatus, wherein the manipulation unit is configured to allow a user to select a cooking mode or a cleaning mode, and the cooking apparatus is configured to remove contaminants caused during cooking by heating the cooking chamber at a temperature of 350±10 [symbol] in response to the cleaning mode being driven.

The heater may include an upper heater, a lower heater and a rear convection heater.

### BRIEF DESCRIPTION OF THE DRAWINGS

FIG. 1 is a cross-sectional view of an interior material of a cooking apparatus, according to an embodiment of the disclosure.

FIG. 2 is a cross-sectional view of an interior material of a cooking apparatus, according to an embodiment of the disclosure.

FIG. 3 schematically illustrates temperature changes over time in a method of removing contaminants, according to an embodiment of the disclosure.

FIG. 4 is a photo representing a state of contamination on an interior material for cooking apparatus after cooking, according to an embodiment of the disclosure.

FIG. 5 is a photo representing a state of contamination on a traditional interior material for cooking apparatus after cooking.

FIG. 6 is a photo for identifying cleanliness of a carbonized contaminant on an interior material for cooking apparatus, according to according to an embodiment of the disclosure.

FIG. 7 is a perspective view illustrating an example of a cooking apparatus, according to an embodiment of the disclosure.

FIG. 8 is a diagram of an interior structure of a cooking apparatus, according to an embodiment of the disclosure.

FIG. 9 is a cross-sectional view illustrating an example of a cooking apparatus, according to an embodiment of the disclosure.

### DETAILED DESCRIPTION

Embodiments of the disclosure will now be described. The embodiments of the disclosure, however, may be modified into many different forms and should not be construed as being limited to the embodiments set forth herein. The embodiments of the disclosure are provided to fully convey the idea provided in the disclosure to scope of the invention to those of ordinary skill in the art.

Terms as herein used are just for illustration. For example, the singular expressions include plural expressions unless the context clearly dictates otherwise.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms used herein have the same meaning as commonly understood by those of ordinary skill in the art to which the disclosure belongs. Furthermore, unless otherwise clearly defined, a specific term should not be construed as having overly ideal or formal meaning. It is to be understood that the singular expression include plural expressions unless the context clearly dictates otherwise.

Throughout the specification, the word ‘about’, ‘substantially’ or the like, is used to indicate that a numerical value used with the word belongs to a range around the numerical value, to prevent an unscrupulous pirate from unduly making an advantage of a description in which the absolute numerical value is mentioned.

The term including an ordinal number such as “first”, “second”, or the like is used to distinguish one component from another and does not restrict the former component.

Furthermore, the terms, such as “˜part”, “˜block”, “˜member”, “˜module”, etc., may refer to a unit of handling at least one function or operation.

The disclosure provides an interior material for cooking apparatus having good heat-resisting properties and strong surface intensity, good anti-staining properties to prevent contaminants from being adhered to and accumulated on inner walls of the cooking apparatus during cooking, making it easy for cleaning, and having restorability from contamination, a cooking apparatus including the interior material therefor and a method for removing stains from the cooking apparatus.

The objective of the disclosure is not limited thereto, and it is obvious to those of ordinary skill in the art that unmentioned other objectives will be clearly appreciated from the following description.

According to an embodiment of the disclosure, healthy surroundings for cooking may be formed, in which contaminants basically fall off to a side without being adhered to or accumulated on inner walls of a cooking apparatus during cooking and the fallen contaminates may be easily swept off or cleaned out with e.g., paper towels.

Contamination after cooking may be reduced to a level of 40% to 50% as compared to a surface coated with enamel, and labor intensity of the user may be significantly reduced in cleaning the contaminants and energy-efficient cleaning is possible by effective cleaning with less energy because the contaminants are not accumulated on inner walls of the cooking chamber.

Furthermore, an eco-friendly cooking apparatus may be provided because cleaning is performed without using a detergent.

In addition, by introducing the interior material according to the disclosure, stains may be removed at a temperature of 400 [symbol] or less, so a risk factor such as gas generation may be eliminated because the cleaning may be performed at a lower temperature than in the traditional cleaning process.

Effects obtainable in the present disclosure are not limited to the above-mentioned effects, and other effects not mentioned may be clearly understood by those of ordinary skill in the art to which the present disclosure belongs from the description below.

An embodiment of the disclosure will now be described in detail with reference to accompanying drawings. Throughout the drawings, like reference numerals or symbols refer to like parts or components.

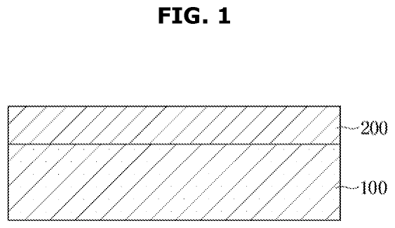

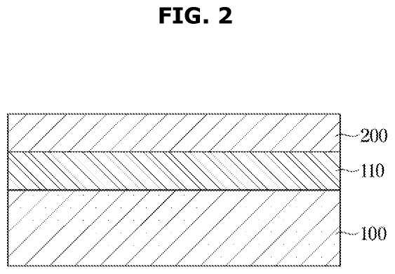

FIGS. 1 and 2 are cross-sectional views of an interior material for cooking apparatus, according to an embodiment of the disclosure.

An interior material for cooking apparatus according to the embodiment of the disclosure includes a coated layer 200 formed on a base material 100. In the disclosure, as shown in FIG. 1, the coated layer is directly painted on the base material 100, or as shown in FIG. 2, the coated layer is pained after an extra process of paining enamel 110 on the surface of the base material 100 to implement an easy-to-clean interior surface for cooking apparatus.

Any material may be used for the base material 100 as long as the material is commonly used for an interior material for cooking apparatus, and the material may include, for example, at least one selected from a group including metal, alloy, stainless steel and glass, without being limited thereto.

The enamel 110 may be provided between the base material 100 and the coated layer 200. Including the enamel 110 contributes to having a glass transition temperature of 600 [symbol] or more, thereby improving heat-resisting performance of the interior material for cooking apparatus.

For example, the enamel 110 may be formed by melting certain proportions of SiO2, TiO₂, Na₂O, Al₂O₃, K₂O, Li₂O, V₂O₅, ZnO, BaO, etc., in frit formation, crushing the materials into small pieces, applying the small pieces of the materials on the base material 100 and performing a firing process at 700 to 950 [symbol] .

The coated layer 200 may be comprised of a silicon backbone for giving heat resistance, surface strength and low surface energy; and a fluorine functional group for preventing contaminant deformation and reducing adherence of the contaminant. That is, the coated layer 200 may give effects of improving heat-resistance, anti-stain and surface strength, and further implement low surface energy. Forming the coated layer may provide a self-falling-off effect of contaminants caused during cooking.

Specifically, the coated layer 200 may be formed of a composition including a silicon-containing compound and a fluorine-containing compound.

More specifically, the coated layer 200 may be optimally formed by applying the composition onto the base material 100 and firing the composition at 200 [symbol] to 400 [symbol] , preferably, 350 [symbol] to 380 [symbol] . In this case, when the firing temperature is too low, a coated layer in which only the silicon backbone is coupled but the fluorine functional group is not bonded is formed, and when the firing temperature is too high, it may not be possible to form the coated layer. Furthermore, in the case of forming the coated layer after enamel is formed on the base material, it is possible to form the coated layer at a lower temperature than for the enamel, thereby increasing productivity and facilitating the manufacturing.

Moreover, a suitable thickness of the coated layer 200 may be selected, but optimal durability of abrasion may be obtained when the coated layer has thickness ranging from 15 [symbol] to 35 [symbol] .

In addition, a suitable proportion between the compounds contained in the composition used to form the coated layer may be selected, but the composition may preferably include the silicon-containing compound of 20 wt % to 60 wt % and the fluorine-containing compound of 20 wt % to 40 wt %. The more the content of the fluorine-containing compound, the lower the surface energy.

Specifically, the silicon backbone is derived from the silicon-containing compound, and any compound that contains at least one functional group among a silanol group, an alkoxysilyl group, and a siloxane group may be used for the silicon-containing compound without being limited thereto. For example, the silicon backbone may be formed in the fomr of polysiloxane, polysilane, dimethyl silicone, etc., but is not limited thereto.

The fluorine functional group is derived from a fluorine-containing compound, and any compound having at least two or more fluorine atoms may be used for the fluorine-containing compound without limitation. As the more the fluorine functional group contained in the coated layer the lower the surface energy implemented, it may be desirable to use a compound with more fluorine atoms.

For the fluorine-containing compound, there may be, for example, polyfluoroalkyl such as perfluoroether, perfluorobutane, perfluorocarbon, perfluorodecaline, perfluoroalkyl (CₙF₂ₙ₊₁R) or the like; fluorotelomer complex; chlorofluoromethane (CHClF₂), dichlorodifluorinated methane (CCl₂F₂); and perfluorides such as perfluoroalkyl carboxylic acids (PFCAs) and perfluoroalkane sulfonic acids (PFSAs), and more specifically, there may be perfluorooctane sulfonic acid (PFOS), perfluorooctanoic acid (PFOA), perfluorohexane sulfonic acid (PFHxS), perfluorononanoic acid (PFNA) and the like. The number of carbon atoms in the alkyl group contained in the fluorine-containing compound is not particularly limited.

The composition for forming the coated layer may further include a coupling agent for assisting bonding between the silicon backbone and the fluorine functional group. For example, the coupling agent may include an alkoxysilane-based compound, a chlorosilane-based compound, a silanol-based compound, an amine-based compound, a carbamate-based compound, an ester-based compound, or an ether-based compound.

In an embodiment, the coated layer 200 may have one of the following compositions, without being limited thereto:

a combination of a compound including a silanol (Si—O—H) group and chlorofluorinated methane or dichlorodifluorinated methane;

a combination of a compound including an alkoxysilane (Si—OR) group, a coupling agent containing a methoxy group or an ethoxy group, and a perfluoroalkyl compound;

a combination of a compound including a siloxane (Si—O—Si) group and a perfluoride.

When food contaminants caused in the process of cooking scatters to interior surfaces of the cooking chamber, the interior material for cooking apparatus according to the disclosure may have low surface energy, which minimizes adhesion of the contaminants, and may thus be wiped down with little force. Specifically, the interior material for cooking apparatus may have a surface energy of 14 mN/m to 30 mN/m. Such low surface energy may contribute to surviving changes in surface energy of contaminants (polymers, fatty acids, etc.) at high temperatures, and when the surface energy is high, heat-resisting and anti-staining properties may be deteriorated.

By introducing such a coated layer to the interior material for cooking apparatus, surface contamination after cooking may be minimized and specifically, remaining contaminants may be reduced to a level of 40% to 50% as compared to the traditional enamel-coated surface. Accordingly, the user's labor effort to clean the contaminants may be noticeably reduced. Furthermore, even some remaining contaminants may be easily removable without using extra energy, leading to effective and energy-efficient cleaning, and the cleaning is performed without a detergent, thereby implementing eco-friendly products.

Moreover, the coated layer 200 may be variously applied even to accessories, cavities, and various parts (racks, a fan cover, a shelf, etc.) in the cooking apparatus.

According to another embodiment of the disclosure, a method of removing a stain from a cooking apparatus including an interior material for cooking apparatus having a coated layer including a silicon backbone and a fluorine functional group formed on a base material, includes heating the cooking apparatus at a certain temperature to pyrolyze components of the stain deposited on a surface of the coated layer (T1); maintaining a temperature equilibrium until the pyrolysis of the stain components is completed (T2); and performing cooling after completion of the pyrolysis of the stain components (T3).

The interior material for cooking apparatus as used herein is equivalent to the aforementioned interior material for cooking apparatus as described above.

For a cooking apparatus including an interior material coated with components including siloxane and perfluoride as main components and accessory parts thereof, the method for removing a stain from the cooking apparatus according to the disclosure is a heating algorithm, i.e., a proportional integral derivation (PID) temperature control method, by which to restore the coated layer having the stain deposited on the coated surface from the long-term use.

The stain may refer to a mark caused by part of a carbon chain of saturated fat such as scattered grease adhered to the coated layer, and the stain may be a contaminant that is not tangible. Furthermore, in the specification, that the stain components are decomposed and completely removed from the coated layer is represented by “restoration of the coated layer” or “surface restoration”.

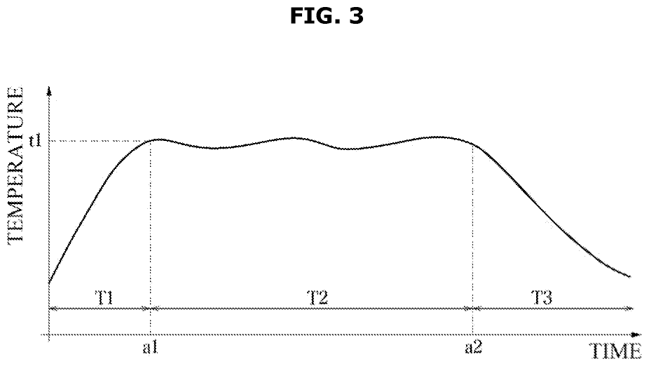

FIG. 3 schematically illustrates a temperature change in each step in a method of removing contaminants, according to the disclosure.

Referring to FIG. 3, T1 section (for heating stain components) is a heating step with rising temperatures for weakening surface-carbon chain bonds that form the stain on the interior surface, which is performed to start Brownian motion by giving heat energy to the deposited contaminants within heating time a1 of a minimum of 5 minutes and a maximum of 20 minutes at a heating temperature t1 of 280 [symbol] to 350 [symbol] .

In an embodiment, heating the cooking apparatus (T1) may include raising the temperature to 280 [symbol] to 350 [symbol] , preferably to 330 [symbol] to 350 [symbol] for 10 to 20 minutes.

T2 section (for separating/removing stain components) is a heating step with constant temperature for releasing carbon chains with weakened bonds to separate contaminants, which is performed by controlling the heating temperature within ±10 [symbol] through on/off control of a heater for 40 to 120 minutes of temperature equilibrium holding time (a2).

In an embodiment, maintaining the temperature equilibrium (T2) may include heating at 350±10 [symbol] for 40 to 120 minutes (a2). The stain includes a carbon chain as a main component, and carbides start to decompose at 330 [symbol] or more, so it is desirable to maintain the temperature equilibrium at at least 330 [symbol] or more to remove the stain.

T3 section (for restoration completion/cooling) is a cooling step for restoration and normal use of the surface of the interior material after the stain is removed, and in this section, the surface is safely cooled after being restored and a locking device works at a safe temperature or higher to protect the user from burns.

In an embodiment, the cooling (T3) may include performing cooling for 20 to 30 minutes.

In another embodiment of the disclosure, a cooking apparatus may include a case 10 including a front panel; a cooking chamber 20 arranged inside the case 10 and accommodating food; a heater 22 arranged to heat the cooking chamber 20; and a door arranged to open or close the cooking chamber, wherein the cooking chamber is formed of an interior material having a coated layer formed on a base material and the coated layer includes a silicon backbone and a fluorine functional group.

The interior material as used herein is equivalent to the aforementioned interior material for cooking apparatus as described above.

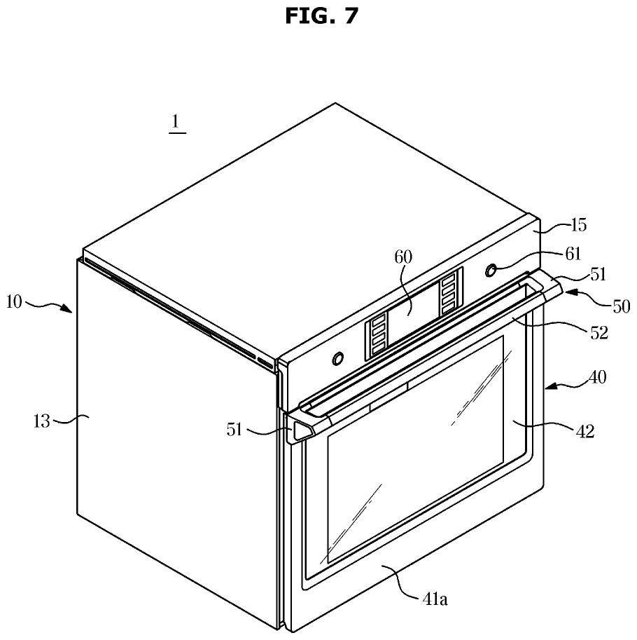

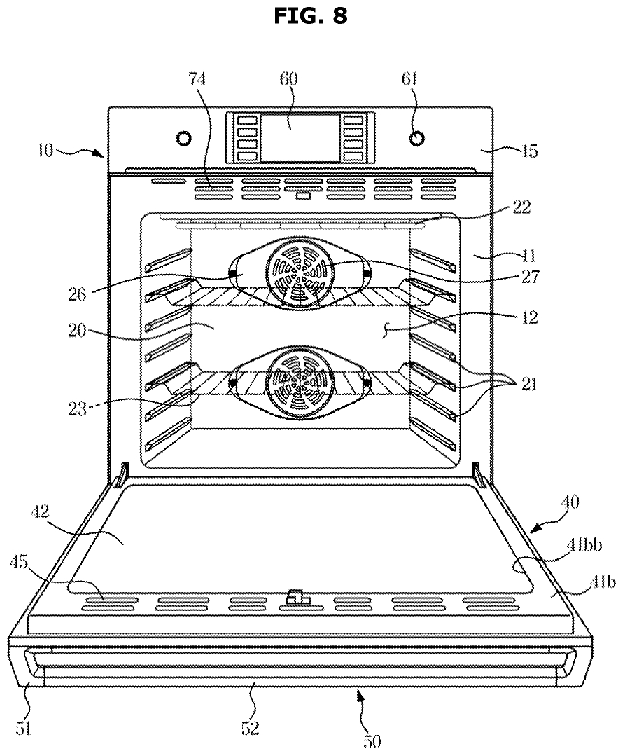

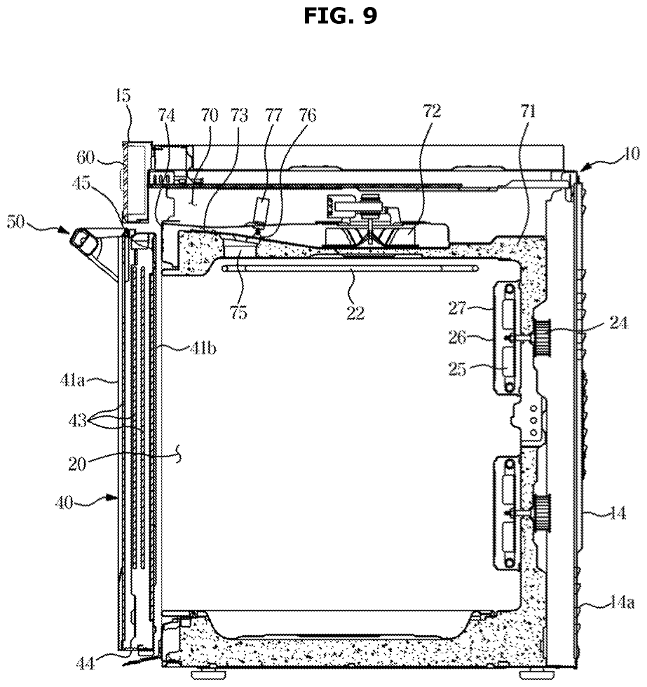

FIGS. 7 to 9 illustrate an example of a cooking apparatus, according to an embodiment of the disclosure.

A cooking apparatus 1 according to an embodiment of the disclosure is a concept including a device capable of cooking food by heating an object to be cooked, e.g., an oven, a microwave, a far-infrared radiation cooker, etc. In the following description, an oven will be taken as an example of the cooking apparatus according to the embodiment of the disclosure, for convenience of explanation.

As shown in FIGS. 7 to 9, the cooking apparatus 1 in the embodiment of the disclosure may include the case 10 and the cooking chamber 20 arranged in the case 10. The case 10 may include a front panel 11 defining a front surface of the case 10, side panels 13 defining side surfaces of the case 10, and a rear panel 14 defining a rear surface of the case 10.

The cooking chamber 20 is provided in the shape of a box in the case 10 and the front side of the cooking chamber 20 may be opened or closed by a door. The front panel 11 may include an opening 12 formed to correspond to the cooking chamber 20 with the front open. The cooking chamber 20 may include a plurality of supports 21 arranged to protrude from left and right walls of the cooking chamber 20. A rack 23 may be mounted on the plurality of supports 21 to put an object to be cooked thereon.

The cooking chamber 20 may be formed of the aforementioned interior material for cooking apparatus according to the disclosure. Furthermore, the interior material with the aforementioned coated layer formed thereon may be equally applied to accessories, cavities, and various parts (racks, a fan cover, a shelf, etc.) in the cooking apparatus.

A heater 22 for heating the interior of the cooking chamber and an object to be cooked may be provided in the cooking chamber 20. In an embodiment of the disclosure, the heater 22 may include a heater for generating electromagnetic waves such as far-infrared rays to heat the object to be cooked. For example, the heater 22 may include an electric heater including an electric resistor. The heater may include an upper heater, a lower heater and a rear convection heater.

A circulation fan 25 to heat the object to be cooked uniformly by circulating air in the cooking chamber 20 and a circulation motor 24 to drive the circulation fan 25 may be provided behind the cooking chamber 20. A fan cover 26 may be arranged in front of the circulation fan 25 to cover the circulation fan 25, and may have through holes 27 formed thereat for air to flow.

The door may be coupled to hinges on a lower side of the case 10 to pivot against the case 10. In another example, the door may be coupled on hinges on a left side or a right side of the case 10.

The door may include a transparent material such as glass 42 through which to check a cooking process on the object to be cooked inside the cooking chamber 20 from outside, and the plurality of glasses 42 may be arranged on the inside of the door. The door may include a front door frame 41a and a rear door frame 41b arranged along edges of the glass. The door may include an air inlet 44 formed at the lower end to allow air to flow into the door. Outside air flowing in through the lower end of the door moves upward inside the door, exchanges heat with hot air from the cooking chamber 20, and is discharged through an air outlet 45 formed at the rear door frame 41b. With this structure, heat inside the door may be cooled by air circulation in the disclosure.

The door may include a handle 50 provided at the upper end of the front surface of the door to be gripped by the user for opening or closing the door.

When the door is coupled to a left hinge or a right hinge of the case 10, the handle 50 may be provided on a right-hand side or a left-hand side of the front surface of the door accordingly. The handle 50 may protrude forward to such an extent as a preset length from the front surface. Specifically, the handle 50 may include a pair of handle supporters 51 extending forward from the front surface of the door 40 and a handle extension 52 making connection between the pair of handle supporters 51.

The cooking apparatus 1 may include a display 60 arranged on an upper front surface of the front panel 11 to display many different operation information items and allow the user to input an operation command. For example, the display may indicate arrival of time to clean the cooking apparatus, and specifically, after a certain period of use, arrival of time for a restorative cleaning process may be indicated for aesthetic or sanitary use.

The display 60 may be arranged on an electric room cover 15. The display 60 may employ a light emitting diode (LED), an organic light emitting diode (OLED), a liquid crystal display, or the like. Alternatively, the display 112 may employ a touch screen panel (TSP) for receiving control commands from the user and displaying operation information corresponding to the received control command. The TSP may include a display for displaying operation information and control commands that may be input by the user, a touch panel for detecting coordinates that come in contact with a body part of the user, and a touch screen controller for determining a control command input by the user based on the coordinates of contact detected by the touch panel.

A manipulation unit may be equipped on the front surface of the case to control operation of the cooking apparatus. The manipulation unit may allow a user to select a cooking mode or a cleaning mode, and in the cleaning mode, contaminants caused during cooking may be removed by heating the cooking chamber at a temperature of 350±10 [symbol] . Alternatively, a manipulation unit may be included to allow the user to select an extra button or function to restore the interior surface by removing stains from the interior material when the user wants.

The touch screen controller may recognize the control command entered by the user by comparing the coordinates touched by the user detected by the touch panel and the coordinates of the control command displayed through the display.

Furthermore, the cooking apparatus 1 may include a manipulator 61 arranged on the electric room cover 15 to allow an additional command to be input to operate the cooking apparatus 1. The cooking apparatus 1 may include an electric room 70 that accommodates electric parts for controlling operations of various parts including the display module 60. The electric room 70 may be arranged above the cooking chamber 20. There may be an insulation member 71 arranged between the electric room 70 and the cooking chamber 20 to insulate the electric room 70 and the cooking chamber 20 to prevent hot air in the cooking chamber 20 from being transferred to the electric room 70.

The insulation member 71 may be arranged to cover not only the electric room 70 and the cooking chamber 20 but also the outside of the cooking chamber 20 on the whole to prevent the hot air from being transferred to the outside of the cooking apparatus 1.

The cooking apparatus 1 may include a cooling structure to cool the electric room 70 by circulating air around the cooking chamber 20. The cooling structure of the cooking apparatus 1 may include a cooling fan unit 72 for circulating air, and a cooling flow path 73 for discharging the air sucked in to the front of the cooking apparatus 1 by the cooling fan unit 72.

The outside air may be sucked into the electric room 70 through the through holes 14a formed at the rear panel 14, and the air sucked into the electric room 70 may be moved around inside the electric room 70 to cool the electric parts therein and then discharged along the cooling flow path 73 to the front of the cooking apparatus 1 through an outlet 74.

Some of the air in the cooking chamber 20 may be sucked in toward the cooling flow path 73 and discharged to the front of the cooking apparatus 1 through a discharge flow path 75. There may be a bypass hole 76 additionally formed to bring some of the air flowing to the outlet 74 from the cooling flow path 73 into the discharge flow path 75. The bypass hole 76 may be opened or closed by an opening/closing device 77, and an amount of air discharged out of the cooking chamber 20 to the cooling flow path 75 may be controlled by the opening or closing of the bypass hole 76.

The disclosure will now be described in detail in the following embodiment. However, the embodiment is for describing the disclosure in more detail and not for limiting the scope of the disclosure.

### EMBODIMENTS

### Embodiment 1 to 6: Manufacturing an Interior Material for Cooking Apparatus Having a Coated Layer Formed Thereon

An interior material sample was prepared by forming a coated layer on an enamel-coated surface using a composition including alkoxysilane for a silicone-containing compound, a methoxy group-containing coupling agent and perfluorodecalin for a fluorine-containing compound.

Furthermore, in each embodiment, the composition for forming a coated layer was manufactured by adjusting the content ratio of the silicone-containing compound and the fluorine-containing compound to a ratio as shown in Table 1 below.

TABLE 1

| | Em- | Em- | Em- | Em- | Em- | Em- |
|---|---|---|---|---|---|---|
| | bodi- | bodi- | bodi- | bodi- | bodi- | bodi- |
| section | ment 1 | ment 2 | ment 3 | ment 4 | ment 5 | ment 6 |
| Si:F | 1:1 | 2:1 | 1:0.6 | 1:0.42 | 1:0.5 | 1:0.25 |
| ratio | | | | | | |

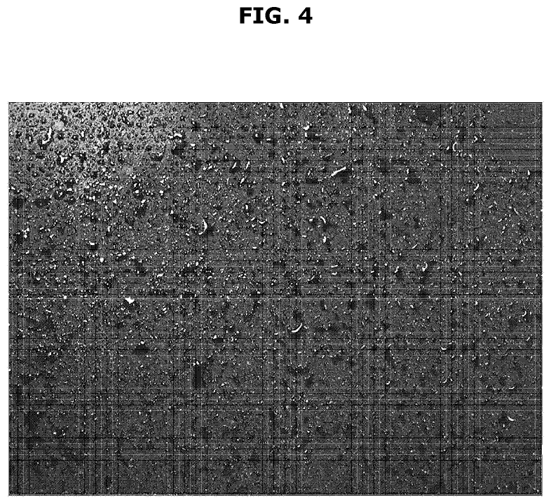

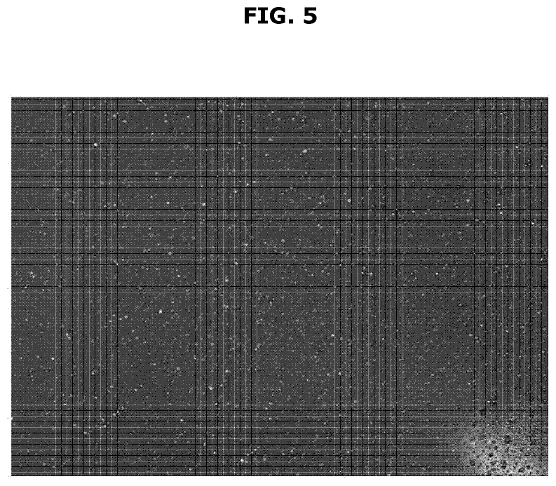

FIG. 4 is a picture of a state in which contaminants scattered during cooking remain on the traditional enamel-coated surface, and FIG. 5 is a picture of a state in which contaminants scattered during cooking remain on a surface with a coated layer formed thereon according to the disclosure.

Comparing degrees of remaining contaminants scattered during cooking with reference to FIGS. 4 and 5, it may be seen that noticeably less contaminants such as grease remain on the surface with the coated layer formed thereon according to the disclosure.

### Experiment Example 1: Evaluation of Contamination Cleanliness

In Table 2 below, it may be seen that the interior materials with the coated layer formed thereon as manufactured in Embodiments 1 to 6 are easy to clean. Furthermore, for comparison of effects, the traditional interior material with enamel coated thereon was used in Comparative example 1.

The cleanliness is evaluated from 0 (bad) to 5 (good), and the evaluation method employed American (cleanliness of contamination 1) and European (cleanliness of contamination 2) methods, which are standard evaluation methods commonly known in the industry.

Specifically, evaluation of cleanliness of contamination 1 in the American method is equivalent to the method as published in step 4 of the Consumer Report, “How to Clean a Dirty Oven and Grimy Stovetop”, and was tested by contaminating the interior of an oven with a mixture of an egg, cheese, cherry pie filling, lard, tomato puree and tapioca, heating the interior at 425 [symbol] (about 218.3 [symbol] ) for an hour, and then cleaning the interior.

Evaluation of cleanliness of contamination 2 in the European method was tested by contaminating the interior of the oven with shortening and gravy sauce mixed in a 1:2 ratio, heating the interior at 550 [symbol] (about 287.8 [symbol] ) for an hour, and then cleaning the interior.

TABLE 2

| | Compar- | Em- | Em- | Em- | Em- | Em- | Em- |
|---|---|---|---|---|---|---|---|
| | ative | bodi- | bodi- | bodi- | bodi- | bodi- | bodi- |
| | exam- | ment | ment | ment | ment | ment | ment |
| section | ple 1 | 1 | 2 | 3 | 4 | 5 | 6 |
| Surface | 50.44 | 15.67 | 17.27 | 24.4 | 25.26 | 26.52 | 27.44 |
| energy | | | | | | | |
| Cleanli- | 1 | 3 | 2 | 5 | 4 | 4 | 3 |
| ness of | | | | | | | |
| contam- | | | | | | | |
| ination | | | | | | | |
| 1 | | | | | | | |
| Cleanli- | 0 | 2 | 1 | 3 | 2 | 2 | 1 |
| ness of | | | | | | | |
| contam- | | | | | | | |
| ination | | | | | | | |
| 2 | | | | | | | |

Referring to Table 2, it may be seen that Embodiments 1 to 6 in which the coated layer is formed have less surface energy and improved cleanliness as compared to Comparative example 1 having the enamel surface.

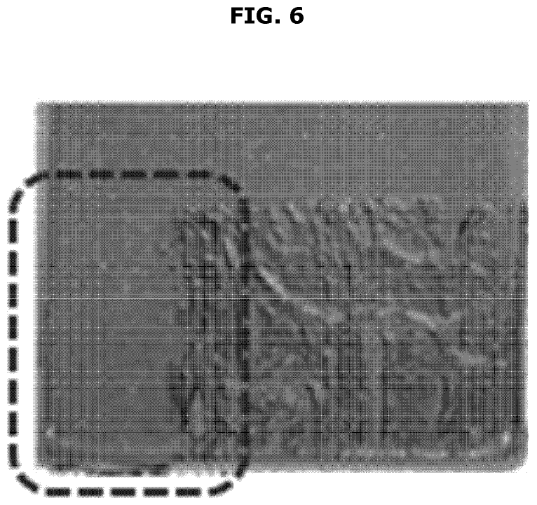

In this regard, FIG. 6 is a picture of a test result of evaluation of cleanliness of contamination 1 on the interior material for cooking apparatus according to the embodiment of the disclosure, and a left portion of FIG. 6 shows that contaminants were cleanly removed without an extra tool.

### Experiment Example 2: Evaluation of Stain Removal (Restoration)

A heating algorithm was performed in the order as shown in FIG. 3 to remove intangible stains possibly present on inner walls of a cavity after the oven is used and then restore the walls into the original state. Specifically, conditions as represented in Table 3 below are given for temperatures and time settings in T1 to T3 sections of FIG. 3 depending on the contamination degree.

In this experiment, Embodiments 3-1 to 3-3 used the same sample as in Embodiment 3 of Table 1 above and Comparative example 1 used an enamel-coated sample.

TABLE 3

| | Comparative | | | |
|---|---|---|---|---|
| | example 1 | | | |
| section | (enamel coated) | Embodiment 3-1 | Embodiment 3-2 | Embodiment 3-3 |
| Contamination | 25% | 25% | 44.7% | 65.3% |
| before heating (%) | | | | |
| Section T1 | Room | Room | Room | Room |
| | temperature ~350 [symbol] , | temperature ~350 [symbol] , | temperature ~350 [symbol] , | temperature ~350 [symbol] , |
| | 20 minutes | 20 minutes | 18 minutes | 18 minutes |
| Section T2 | 350 [symbol] ± 10 [symbol] , | 350 [symbol] ± 10 [symbol] , | 350 [symbol] ± 10 [symbol] , | 350 [symbol] ± 10 [symbol] , |
| | 40 minutes | 40 minutes | 80 minutes | 120 minutes |
| Section T3 | 350 [symbol] ~ room | 350 [symbol] ~ room | 350 [symbol] ~ room | 350 [symbol] ~ room |
| | temperature, | temperature, | temperature, | temperature, |
| | 30 minutes | 30 minutes | 25 minutes | 27 minutes |
| Contamination | 24% | 0% | 2% | 0% |
| after heating (%) | | | | |

Referring to Table 3, it may be seen that in the case of Embodiments 3-1 to 3-3 in which a coated layer is formed according to the disclosure, the whole or most of the contaminants are removed by going through the heating algorithm according to the disclosure regardless of the contamination degree.

On the other hand, in the case of Comparative example 1 having the enamel-coated surface, the contaminants were not practically removed even the heating algorithm according to the disclosure had been performed. Through this, it may be seen that a low-temperature (400 [symbol] or less) heating algorithm may work to remove stains only when the coated layer is formed according to the disclosure as compared to the traditional Pyrolytic cleaning.

Embodiments of the disclosure have thus far been described, but the disclosure is not limited thereto, and it will be obvious to those of ordinary skill in the art that various modifications and alterations can be made without deviating from the scope of the appended claims.

What is claimed is:

1. An interior material for cooking apparatus comprising:
a coated layer formed on a base material,
wherein the coated layer comprises a silicon backbone and a fluorine functional group, having improved heat-resisting and anti-staining properties.

2. The interior material for cooking apparatus of claim 1, further comprising:
enamel provided between the base material and the coated layer.

3. The interior material for cooking apparatus of claim 1,
wherein the silicon backbone is derived from a silicone-containing compound including one or more functional groups of a silanol group, an alkoxysilyl group and a siloxane group, and
wherein the fluorine functional group is derived from a fluorine-containing compound having at least two fluorine atoms.

4. The interior material for cooking apparatus of claim 3, wherein the coated layer is formed of a composition including 20 wt % to 60 wt % of the silicon-containing compound and 20 wt % to 40 wt % of the fluorine-containing compound.

5. The interior material for cooking apparatus of claim 4, wherein the composition comprises one or more coupling agents selected from a group including an alkoxysilane-based compound, a chlorosilane-based compound, a silanol-based compound, an amine-based compound, a carbamate-based compound, an ester-based compound, and an ether-based compound.

6. The interior material for cooking apparatus of claim 3, wherein the coated layer is formed by sintering a composition including the silicon-containing compound and the fluorine-containing compound at 200 to 400 [symbol] .

7. The interior material for cooking apparatus of claim 1, wherein the interior material for cooking apparatus has a surface energy of 14 mN/m to 30 mN/m.

8. The interior material for cooking apparatus of claim 1, wherein the base material comprises at least one selected from a group including metal, alloy, stainless steel and glass.

9. A method of removing a stain from a cooking apparatus, the method comprising:
heating the cooking apparatus at a certain temperature to pyrolyze components of the stain deposited on a surface of a coated layer, the cooking apparatus including an interior material having the coated layer including a silicon backbone and a fluorine functional group formed on a base material;
maintaining a temperature equilibrium until the pyrolysis of the stain components is completed; and
performing cooling after completion of the pyrolysis of the stain components.

10. The method of claim 9,
wherein the heating of the cooking apparatus comprises raising the temperature to 280 [symbol] to 350 [symbol] for 10 to 20 minutes,
wherein the maintaining of the temperature equilibrium comprises performing heating at 350±10 [symbol] for 40 to 120 minutes, and
wherein the performing of the cooling comprises performing cooling for 20 to 30 minutes.

11. The method of claim 9, wherein the stain comprises a carbon chain as a main component.

12. The method of claim 9, wherein the interior material for cooking apparatus comprises enamel provided between the base material and the coated layer.

13. A cooking apparatus comprising:
a case including a front panel;
a cooking chamber arranged inside the case to accommodate food;
a heater configured to heat the cooking chamber; and
a door arranged to open or close the cooking chamber,
wherein the cooking chamber is formed of an interior material having a coated layer formed on a base material, and
wherein the coated layer comprises a silicon backbone and a fluorine functional group.

14. The cooking apparatus of claim 13, further comprising:
a display configured to indicate a time for cleaning the cooking apparatus; and
a manipulation unit arranged on a front surface of the case to control an operation of the cooking apparatus,
wherein the manipulation unit is configured to allow a user to select a cooking mode or a cleaning mode, and
wherein the cooking apparatus is configured to remove contaminants caused during cooking by heating the cooking chamber at a temperature of 350±10 [symbol] in response to the cleaning mode being driven.

15. The cooking apparatus of claim 14, wherein the heater comprises an upper heater, a lower heater and a rear convection heater.
